(19) United States
(12) Patent Application Publication
(10) Pub. No.: US 2009/0226755 A1
(43) Pub. Date: Sep. 10, 2009

(54) Laminated steel sheet

(75) Inventors: David R. Sigler, Shelby Township, MI (US); James G. Schroth, Troy, MI (US)

Correspondence Address: General Motors Corporation;c/o REISING, ETHINGTON, BARNES, KISSELLE, P.C., P.O. BOX 4390, TROY, MI, 48099-4390, US

(73) Assignee: GM Global Technology Operations, Inc., Detroit, MI (US)

(21) Appl. No.: 12/389,442

(22) Filed: Feb. 20, 2009

Related U.S. Application Data
(60) Provisional application No. 61/035,120, filed on Mar. 10, 2008.

(51) Int. Cl. B32B 15/08

(52) U.S. Cl. 428/626

(57) ABSTRACT

Steel sheet-viscoelastic core laminates are often subject to corrosion in moisture-containing environments. Zinc-based alloys of iron may be beneficially applied to the inner faces of the steel sheets or to both the inner and outer sheet faces. Substantially pure zinc coatings may be applied over the zinc-iron alloys or over an otherwise base outer steel sheet surface. Combinations of such zinc-iron alloy coatings and substantially pure zinc coatings improve the corrosion resistance of the steel sheet-polymer core laminates while supporting weldability and paintability.

This application claims the benefit of U.S. Provisional Application No. 61/035,120, titled “Laminated Steel Sheet”, and filed Mar. 10, 2008, and which is incorporated herein by reference.

### TECHNICAL FIELD

This invention pertains to laminated steel articles formed of thin outer steel skin sheets sandwiching a viscoelastic polymeric core material. More specifically, this invention pertains to combinations of substantially pure zinc and zinc-iron alloy coatings for the steel sheets for facilitating corrosion resistance, resistance spot welding, and drawn arc stud welding in the laminated article.

### BACKGROUND OF THE INVENTION

Laminated steels have been adopted for use in automotive vehicles. The outer steel skin sheets may have thicknesses of, for example, about one-half millimeter to about two millimeters and provide the laminate with structural integrity. The viscoelastic polymeric core layer has a typical thickness of about 20 to 50 micrometers to provide sound-damping or other useful properties in the laminate. For example, these sheet laminates are shaped into vehicle body panels that reduce vehicle vibrations generating noise in the passenger compartment. Laminates with thicker cores may be used in other applications.

The steel compositions are selected for their strength and formability, and for welding or other joining practices in making the vehicle body. Since the laminates are often exposed to water, humid atmospheres, and salt, the steel must be protected from corrosion. The exterior surfaces of current, commercial laminated steel products may be protected from corrosion by one or more of galvanized coatings, zinc phosphate layers, e-coat layers, and additional polymer paint coatings.

Some current versions of laminated steel consist of electro-galvanized or hot-dip galvanized thin steel sheets (˜0.5 mm) that are laminated together with a thinner, sound damping viscoelastic core. Galvanizing results in a material with about 60 g/m² (about 8.4 micrometers thick) of zinc on the exposed exterior surfaces of the steel sheets as well as the two interior surfaces. This zinc presence for the most part controls the corrosion resistance of the laminated steel by, first, forming a protective zinc carbonate barrier when exposed to the atmosphere and, second, by cathodically protecting portions of the steel that are not directly covered by a zinc layer.

Manufacturing operations such as laminate forming, spot welding, piercing, flanging, shearing and others can cause local delamination of an outer steel layer from the polymer material. This delamination provides both a geometric irregularity in the laminate surface as well as an opening for ingress of moisture between the laminate interior surfaces. Further, in addition to causing local delamination, welding of a laminate can locally vaporize surface zinc which leaves areas of reduced protection adjacent to welds. When these welds are near the periphery of a panel, they can be exposed to moisture. In any case, moisture that migrates between the steel skin sheets can quickly consume the very reactive zinc located on the interior surfaces beneath the outermost zinc carbonate barrier to ultimately cause expedited perforation corrosion of the laminate. Laminated steels containing 60 g/m² of zinc coating on the interior surfaces have been found to survive only 5 to 6 years in regions of severe service. To meet vehicle customer needs, the laminate must have significantly improved corrosion resistance while maintaining other beneficial characteristics such as good paintability, formability, and welding performance.

There remains a need for corrosion resistant coatings for steel laminates that accommodate forming, joining, painting and other vehicle body making operations and provide long term protection against corrosion.

### SUMMARY OF THE INVENTION

In accordance with embodiments of this invention, combinations of substantially pure zinc coatings and zinc-iron alloy coatings are applied to surfaces of thin steel skin sheets for use in steel laminate blanks. In one embodiment, the laminated steel sheet may include two steel skin sheets with facing surfaces bonded by a polymer core layer. The combinations of these zinc and zinc-iron alloy coatings are used to improve the corrosion resistance of the steel skin sheets in contact with polymer core layers and improve the laminate's behavior, i.e. tendency to delaminate, during resistance spot welding. The coatings are placed to facilitate forming of the sheet laminates into vehicle body panels and the like, and to permit their use in welding, painting, and other vehicle body making operations.

Substantially pure zinc (99⁺% Zn) coatings have been applied to iron and steel articles by hot-dipping (at about 460° C.) and lower temperature electrolytic processes to provide galvanized parts. The thin substantially pure zinc coating (typically about 8 micrometers thick) acts as a barrier and as a sacrificial anode to resist corrosion. In practices of this invention, zinc-iron alloy coatings containing about five to about thirty weight percent iron and the balance substantially zinc (except for possible small amounts of other elements up to about 0.2%) are sometimes used in combination with such known “substantially pure” galvanized zinc coatings. Unless otherwise stated, a reference in this specification to substantially pure zinc refers to at least 99 weight % zinc, up to and including completely pure (100 weight %) zinc.

In preferred embodiments of the invention, the zinc-iron alloys may be applied as co-extensive coatings to one or both sides of the steel skin sheet before the polymeric core material is applied to one or both sheets in assembly of the laminate. Substantially pure zinc layers may be applied over the zinc-iron alloy layers or on otherwise uncoated steel sheet surfaces before or after assembly of the laminate.

In one embodiment of the invention, zinc-iron alloy coatings are applied to both the surfaces of the steel skin sheets and substantially pure zinc coatings are applied over the zinc-iron coatings. The assembled laminate thus has two distinct coating layers on both outer steel skin sheet surfaces of the laminate and on the inner steel sheet surfaces facing the polymeric core material. In this example, the zinc-iron coatings provide most of the corrosion resistance and are about four to twelve micrometers thick, while the outer substantially pure zinc would be thinner: approximately one micrometer thick. In another embodiment, the zinc-iron coating may be about two to about twenty micrometers thick.

In a second embodiment of the invention, zinc-iron alloy coatings are applied to both the surfaces of the steel skin sheets but substantially pure zinc coatings are applied over the zinc-iron coatings only on the outer steel sheet surfaces of the laminate. Again, the zinc-iron coatings provide most of the corrosion resistance and would be about four to twelve micrometers thick, while the substantially pure zinc on the laminate exterior would provide paintability and would be thinner: approximately one micrometer thick. In another embodiment, the zinc-iron coating may be about two to about twenty micrometers thick.

In a third embodiment of the invention, a zinc-iron alloy coating is applied to each of the intended inner steel skin sheet surfaces and a relatively heavy coating of substantially pure zinc is applied to the outer surfaces of the steel laminate. The zinc-iron alloy coating on the inner surface provides protection of that surface and would be about four to twelve micrometers thick, while the substantially pure zinc coating on the laminate exterior would provide both corrosion resistance and paintability and would be approximately six to twelve micrometers thick. In another embodiment, the zinc-iron alloy coating may be about two to about twenty micrometers thick.

A preferred usage of substantially pure zinc and/or zinc-iron alloy coating layers (e.g., steel sheet side locations and thicknesses) can be chosen for the steel skin sheet surfaces of a laminate specifically for the anticipated corrosion environment of a laminate part and the various manufacturing operations by which the part is formed, welded, painted, or the like. An outer layer of substantially pure zinc may be preferred to accommodate, for example, painting. But the zinc-iron alloy is utilized for improved resistance to corrosion from moisture and improved weldability by reducing zinc vaporization that causes delamination.

Additional coatings may be provided over the zinc-iron alloy coatings and zinc galvanized coatings applied to the steel sheet surfaces. For example, zinc phosphate layers, e-coat layers, and polymer paint coatings may be applied to the pre-coated steel sheet surfaces, especially the outer sheet surfaces.

Other objects and advantages of the invention will be understood from detailed descriptions of preferred embodiments which follow in the text below and the drawings which are described below.

### BRIEF DESCRIPTION OF THE DRAWINGS

FIG. 1 is an oblique view of a laminated steel front-of-dash vehicle body panel. This is an illustration of a vehicle body component that may be formed of laminated steel sheet material. Although not visible in FIG. 1, the laminated steel sheet comprises two steel skin sheets with facing surfaces bonded by a viscoelastic polymeric core layer. The core layer comprises electrically conductive particles. The following drawing figures of edges of the panel illustrate the layers of the laminated steel panel and the corrosion-resisting coating strategies for the inner and outer surfaces of the steel sheets.

FIG. 2 is a schematic, enlarged view of a portion of an edge (at location 2 in FIG. 1) of the laminated steel panel of FIG. 1 illustrating a first corrosion protection embodiment of the invention. In FIG. 2, both inner and outer surfaces of the steel sheets are coated with a zinc-iron alloy layer and with a thin overlying substantially pure zinc layer.

FIG. 3 is a schematic, enlarged view of a portion of an edge (at location 2 in FIG. 1) of the laminated steel panel of FIG. 1 illustrating a second corrosion protection embodiment of the invention. In FIG. 3, both inner and outer surfaces of the steel sheets are coated with a zinc-iron alloy layer. The outer surfaces of the steel sheets have a thin overlying substantially pure zinc layer.

FIG. 4 is a schematic, enlarged view of a portion of an edge (at location 2 in FIG. 1) of the laminated steel panel of FIG. 1 illustrating a third corrosion protection embodiment of the invention. In FIG. 4, the inner surfaces of the steel sheets are coated with a zinc-iron alloy layer and the outer surfaces of the sheets are coated with a relatively thick substantially pure zinc layer.

### DESCRIPTION OF PREFERRED EMBODIMENTS

Various embodiments include a new laminated steel product, such as a body panel, that displays improved corrosion resistance and spot weldability while maintaining sound damping, sheet formability, and painting properties. The corrosion resistance and improved spot weldability of polymer core laminated steel is accomplished by the arrangement of protective layers applied to the steel skin sheet material.

The exterior surfaces of prior art laminated steel products have been protected by one or more of galvanized coatings, zinc phosphate layers, e-coat layers, and additional polymer paint coatings. The interior surfaces, however, have only been protected by a substantially pure zinc galvanized layer. The zinc layer is very reactive and can be consumed quickly on exposure to moisture that has migrated between the skin sheets from material delamination. To obtain longer material life and improved weldability, alternative coatings are desired that slow the corrosion reaction and reduce zinc volatilization during welding.

This invention makes use of zinc-iron alloy coatings for making a steel skin sheet useful for forming laminates such as automobile articles that comprise a viscoelastic polymer core material sandwiched between two such steel skin sheets. The steel skin sheets are devised to exhibit improved corrosion resistance to the laminate and improved resistance spot weldability while maintaining the useful properties that permit the laminate to be, among others, (1) painted with acceptable paint formulations including the application of industry-standard cathodic electrodeposition primer systems, and (2) formed into body panels of complex shape. Zinc-iron alloys comprising primarily, by weight, about five to thirty percent iron and the balance substantially zinc (except for unavoidable impurities) are adaptable for this combination of requirements.

With regards to corrosion resistance, Zn—Fe alloy coatings are considered to be less reactive than the pure zinc galvanized coatings of the prior art. Thus, to achieve improved perforation corrosion resistance, the steel skin sheet of this invention utilizes a Zn—Fe alloy on at least its interior sheet surface—the surface that ultimately faces the polymer core material. The opposed exterior surface of the sheet may also be similarly coated.

But with this in mind it should be noted that Zn—Fe coatings do not fare as well as pure galvanized zinc coatings during certain painting processes, such as electrodeposition dip processes (ELPO). The nature of the intermetallic Zn—Fe coating and the relatively high voltages utilized in ELPO processes tends to be somewhat incompatible. It is therefore advisable to have a substantially pure zinc coating applied over a Zn—Fe alloy coating of the steel skin sheet. This is especially true on the exterior surface of the sheet where paint is applied

Another reason to have a substantially pure zinc coating overlying a Zn—Fe alloy coating on the exterior surface of the steel skin sheet relates to formability. For instance, under some circumstances it has been found that a steel laminate is more difficult to form than a solid steel sheet of similar gauge. And it is also known that substantially pure zinc coatings provide better lubricity and formability than comparative coatings of Zn—Fe alloy which are slightly more prone to cracking when subjected to normal forming stresses and engagements. Thus, in addition to the improved painting characteristics just discussed, a steel skin sheet that has a Zn—Fe alloy coating and an overlying coating of substantially pure zinc on its exterior surface should be more amenable to being formed against a tool than if only the Zn—Fe alloy coating were present.

The use of only a substantially pure zinc coating on both the interior and exterior surfaces of the steel skin sheet has been found to adversely affect the weldability of the laminate. The low melting and boiling points of substantially pure zinc coatings result in zinc volatilization during resistance spot welding, which causes local delaminations. These delaminations can provide an opening for moisture ingress and corrosion as well as geometrical disturbances to the surface that can interfere with assembly. It has been observed that a steel skin sheet coated only with a Zn—Fe alloy is easier to resistance spot weld than a galvanized steel skin sheet having only a substantially pure zinc coating thereon. And a more spot weldable material may eliminate the need to provide the laminate with additional thickness or mass (a mass penalty) to make it more forgiving during spot welding, as has been done in the past and is currently being done.

The improved weldability of Zn—Fe alloy coated steel sheets over sheets coated with only substantially pure zinc can be attributed to the relatively low melting point of the zinc coating. For one, the lower melting point of substantially pure zinc requires higher welding currents because contact between molten zinc and the welding electrode results in a low electrical resistance between the electrode and the steel skin sheet. And second, the molten zinc tends to react with the copper electrodes used in resistance spot welding to form Cu—Zn or brass layers on the contacting surface of the electrode. These layers contribute to deformation at the weld face during repeated or extensive welding and can result in mushrooming or further undesirable expansion of the weld face. If this occurs the life of the welding electrode is usually cut short while higher currents are needed to counteract the effects of the growing weld face.

For laminates coated with substantially pure zinc, the higher required welding currents will result in higher currents passing through the conductive particles contained within the viscoelastic core. This will significantly increase the likelihood that the particles overheat and melt through or perforate the skin sheet material. Lastly, substantially pure zinc coatings tend to readily vaporize within the laminate during resistance spot welding and drawn arc stud welding and as a result contribute to further delamination. Substantially pure zinc coatings on the interior and exterior surfaces of the steel skin sheet may therefore need to be minimized if the sheet's best welding performance is sought to be achieved.

Each of these issues (corrosion resistance, paintability, formability, and weldability) may be considered and balanced against one another when devising how to utilize the Zn—Fe alloy coatings of this invention to make steel skin sheets for use in sound-damping laminates. As can be expected some of these issues may be quite important while the others are easily ignorable depending on how the steel skins sheets and the formed laminate are utilized and/or subsequently processed. Specific illustrative embodiments of laminates and their steel skin sheets that utilize a Zn—Fe alloy coating are provided below.

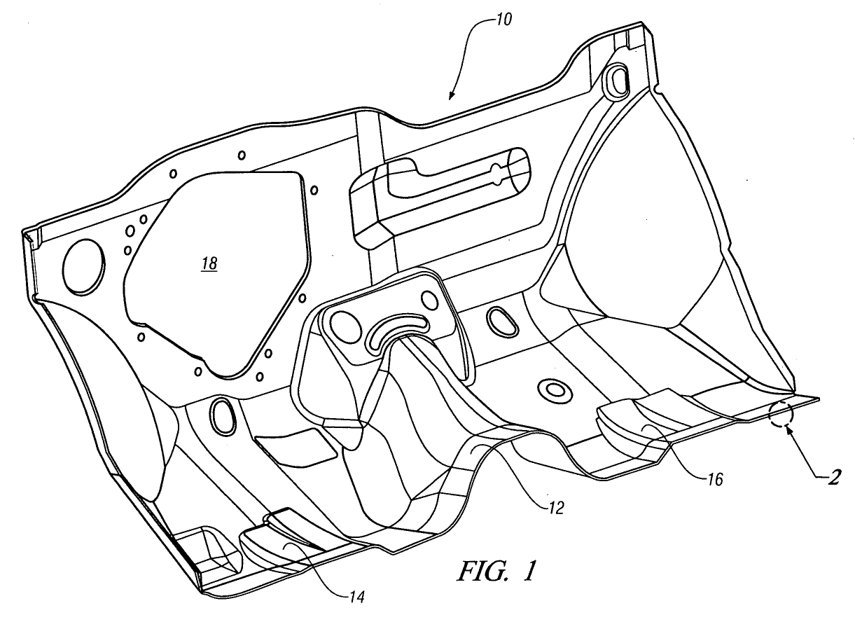

FIG. 1 illustrates a laminated steel front-of-dash panel 10 for a passenger vehicle. As illustrated, the panel is a single formed and trimmed piece of steel laminate. As seen, it is a panel of complex shape that lies below the front windows of a vehicle passenger compartment and forward of the front doors. Panel 10 has experienced significant shaping into this body component. Panel 10 includes a tunnel shaped portion 12 to overlie vehicle drive train parts and shaped portions 14, 16 for leg room for driver and passenger. Also, a portion 18 of the panel has been cut out for a steering column, not shown. Other portions of the panel have been removed for pass-through of wiring and the like.

The steel skin sheets forming the surfaces of the laminate may be coated with substantially pure zinc and with zinc-iron alloy layers in accordance with practices of this invention before the laminate is made. After shaping a laminate blank into a panel 10 other body pieces may be welded or otherwise attached to the dash panel. And surfaces of this panel or of other steel laminate panels may be painted or provided with other coatings in the making of a full vehicle body structure.

The thicknesses of sound damping laminates used in such vehicle body applications are typically in the range of about 0.8 mm to 1.4 mm. In such steel laminates each steel skin sheet may be about 0.40 mm to 0.70 mm thick and the viscoelastic polymer core may be about 0.020 mm to about 0.050 mm thick. The viscoelastic polymer core is often about 0.050 mm (fifty micrometers) thick. In another embodiment, each steel skin sheet may be about 0.50 mm to about 2 mm thick.

Low carbon steel skin sheet compositions are often used in steel laminate automotive body applications. Typical steel grades used include, for example, low carbon steels SAE J2329 CR4 and SAE J2329 CR5. Higher strength steels may be used when their strength properties are required. A nominal CR4 low carbon steel composition (wt %) comprises up to about 0.08% C, up to about 0.40% Mn, less than 0.025% P, less than 0.020% S, about 0.015% Al, and the balance substantially iron except for incidental impurities. Sometimes 0.01% to 0.03% of Ti or Nb is added. The tensile strengths of CR4 steels are typically in the range of 270 to 330 MPa, yield strengths of 140 to 180 MPa, with tensile elongations greater than about 40%. A nominal CR5 low carbon steel composition (wt %) comprises up to about 0.02% C, <0.25% Mn, <0.020% P, <0.020% S, >0.015% Al, and iron. Sometimes 0.01% to 0.03% of Ti or Nb is added. Tensile strengths of CR5 steels are typically greater than 260 MPa, yield strengths are about 110 to 180 MPa, and tensile elongations >42%.

The polymer core layers in steel laminates for automotive panels are often very thin, typically about 0.020 mm to 0.050 mm in layer thickness. The core layer(s) in a laminate is usually co-extensive with the facing surfaces of the sandwiching steel sheets. A typical laminate comprises two steel sheets of like shape and area with a single co-extensive polymer core-layer. But some laminates comprise three or more steel sheets with interposed polymer cores between each sheet.

The core layers may be filled with electrically conductive particles to enable electrical conductivity between the steel sheets through the nonconductive polymer material. Such conductivity may be utilized, for example, in electrical resistance welding or in electrolytic application of paint or other coating layers. The conductive particles are typically sized to match the thickness of the polymer core, about 20 to 50 micrometers in automotive vehicle body laminates. Most laminates use pure Ni particles, stainless steel particles, or Fe-phosphide particles. In other laminate embodiments, Fe particles, Al particles, and/or Cu particles may be used. Typically the conductive particles make up about one to two volume percent of the polymer core material.

A number of polymer core compositions have been developed for steel laminates for automotive applications. Different families of viscoelastic core materials are known and commercially available. Some of the core materials are based on elastomer compositions such as styrene-butadiene rubber (SBR), and styrene-ethylene/butylene-styrene terpolymer (SEBS). Some are based on acrylic copolymers such as acrylic acid ester copolymer, styrene-acrylic copolymer, or its polymer blends with styrene-butadiene. Some core materials are based on polyvinyl acetate (VA), or its copolymers such as ethylene vinyl acetate copolymer or ethylene-vinyl acetate-maleic anhydride terpolymer. And some core materials are based on epoxy based block copolymer such as epoxy polyester block copolymer or epoxy polyether block copolymer.

Practices of this invention relate generally to steel laminates in which one or more combinations of substantially pure zinc coatings and zinc-iron alloy coatings have been applied to inner surfaces (i.e., facing the polymer core) and outer surfaces (i.e., opposite the polymer core) of the steel sheets. The following are some illustrative embodiments of the practice of the invention.

In a first embodiment, a laminate is produced with steel skin sheets that have both exterior surfaces and both interior surfaces coated with substantially pure zinc and an underlying Zn—Fe alloy coating. The final laminated product has a viscoelastic layer containing conductive particles located between the skin sheets. This laminate is particularly suitable for vehicle body applications.

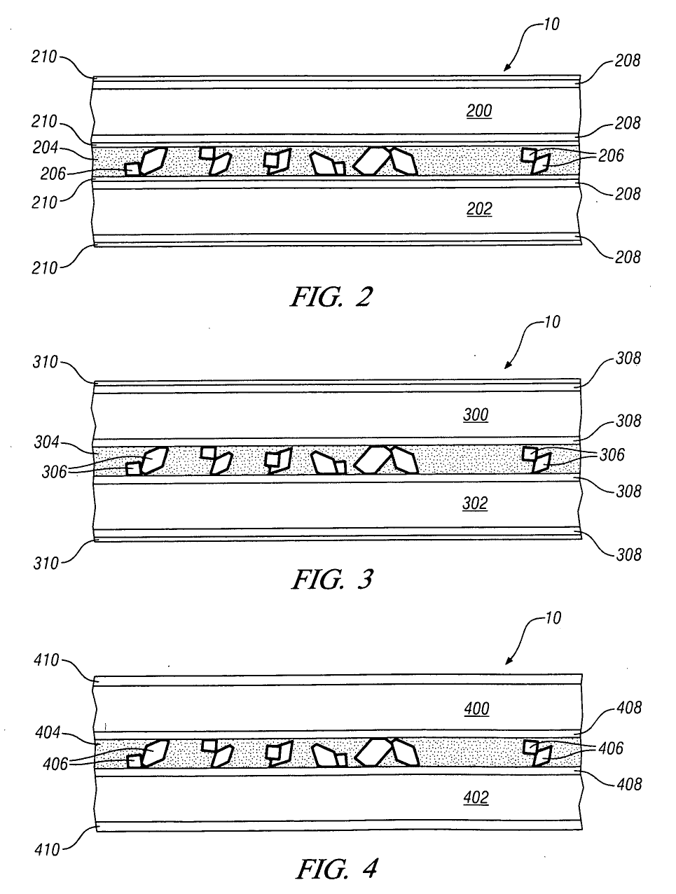

The resulting structure is shown in an edge portion (at location 2) of panel 10 of FIG. 1. In this embodiment, the panel 10 steel laminate comprises a first steel skin sheet 200, and a second steel skin sheet 202 that sandwich a viscoelastic polymer core layer 204 that is generally co-extensive with facing surfaces of steel skin sheets 200, 202. FIG. 2 is enlarged for purposes of illustration and not drawn to scale. Each steel sheet 200, 202 may be about 0.5 mm thick and the polymer core layer may be about 0.04 mm thick and coextensive with identical facing surfaces of sheets 200, 202. It is seen that each steel sheet 200, 202 has a surface facing polymer core layer (termed an inner surface) and a surface opposite the core layer (termed an outer surface).

Polymer core 204 comprises conductive particles 206 dispersed in an amount to provide suitable electrical conductivity through the usually non-conductive core material and between the inner surfaces of the skin sheets 200, 202. Typical conductive particles include copper, iron, iron-phosphides, stainless steel, aluminum, and preferably nickel. These would be preferably sized to span the gap (about 0.04 mm, about 40 micrometers) between the sheets (many particles touching each facing sheet) that is formed by the viscoelastic core during the laminating process.

In this embodiment, both inner and outer surfaces of both steel skin sheets 200, 202 are coated with a layer 208 of zinc-iron alloy. In this example, the zinc-iron alloy comprises about 10 weight percent iron and 90 weight percent zinc. In other embodiments, the zinc-iron alloy may comprise about 9 to about 12 weight percent iron. In another embodiment, the zinc-iron alloy may comprise from about 5 weight percent up to about 30 weight percent iron. Layer 208 is about 0.004 mm to about 0.012 mm thick. In another embodiment, the layer 208 may be about 0.002 mm to about 0.020 mm thick. Thus, laminate 10 comprises four zinc-iron alloy layers 208. Each zinc-iron layer 208 is coated with a thin substantially pure zinc layer 210 that is about one micrometer thick. Thus, zinc galvanized layers 210 on the internal sides of steel sheets 200, 202 contact polymer core layer 204 (and conductive particles 206) and the zinc galvanized layers 210 on the outside steel sheet faces of the panel laminate 10 are exposed to the panel environment.

In this embodiment, the exterior substantially pure zinc layers can be used to provide painting performance, including the use of high-voltage electrodeposition processes (ELPO), similar to that of zinc-only coated steel sheets. The substantially pure zinc layers can also provide good lubricity for forming. On the other hand, the Zn—Fe alloy layer 208 beneath each zinc layer 210 on the interior surfaces provides improved corrosion protection compared to a single galvanized zinc coating. But placing a substantially pure zinc layer on the interior surface may cause some additional issues with both resistance spot and stud welding, as discussed before. Thus, by using a very thin substantially pure zinc layer, spot welding should be superior to that obtained by a typical, heavier galvanized coating while maintaining good corrosion resistance.

A method for producing the laminate structure of this embodiment comprises, first, either hot-dip coating a pair of steel skin sheets with zinc and then annealing the sheets to obtain a Zn—Fe diffusion layer or coating at the sheet surfaces, or electro-galvanizing a pair of steel skin sheets with a Zn—Fe coating. Next, the pair of steel skin sheets may be electro-galvanized with zinc to apply substantially pure zinc coatings over the Zn—Fe alloy coatings. And finally the two sheets may be laminated together with a viscoelastic core material that contains conductive particles.

In a second embodiment a laminate is produced that has steel skin sheets with Zn—Fe alloy layers on both interior and exterior surfaces. A substantially pure zinc layer is located only on the laminate exterior surfaces. The laminate contains a viscoelastic core with conductive particles.

The resulting structure is shown in FIG. 3 looking at an edge portion (at location 2) of panel 10 of FIG. 1. In this embodiment, the panel 10 steel laminate comprises a first steel skin sheet 300, and a second steel skin sheet 302 that sandwich a viscoelastic polymer core layer 304 that is generally co-extensive with facing surfaces of steel skin sheets 300, 302. Again, it is seen that each steel skin sheet 300, 302 has a surface facing polymer core layer (termed an inner surface) and a surface opposite the core layer (termed an outer surface). And again polymer core 304 comprises dispersed conductive particles 306 to provide suitable electrical conductivity through the usually non-conductive core material and between the inner surfaces of the sheets.

Steel skin sheets 300, 302 are about 0.5 mm thick and polymer core layer 304 is about 0.04 mm thick.

In this embodiment, both inner and outer surfaces of both steel skin sheets 300, 302 are coated with a layer 308 of zinc-iron alloy. In this example, the zinc-iron alloy comprises about 10 weight percent iron and 90 weight percent zinc. In other embodiments, the zinc-iron alloy may comprise about 9 to about 12 weight percent iron. In another embodiment, the zinc-iron alloy may comprise from about 5 weight percent up to about 30 weight percent iron. Thus, laminate 10 comprises four zinc-iron alloy layers 308 each about 0.004 mm to about 0.012 mm thick. In another embodiment, the layers 308 may be about 0.002 mm to about 0.020 mm thick. But in this embodiment only the outer zinc-iron layers 308 are coated with a thin substantially pure zinc layer 310 about one micrometer thick. Thus, zinc galvanized layers 310 on the outside steel skin sheet faces of the panel laminate 10 are exposed to the panel environment. Zinc-iron alloy layers 308 on the inside steel sheet faces contact the polymer core layer 304 and conductive particles 306.

In this second embodiment the laminate would have the potential painting performance of galvanized steel sheet. The exterior zinc layer would also add lubricity for forming. In addition, the Zn—Fe alloy layer on the interior surfaces should provide improved corrosion protection compared to a similar coating weight of substantially pure zinc. Finally, an interior surface with only a Zn—Fe alloy coating should help both resistance spot and stud welding performance.

A suitable method to produce the coating layer combinations of this second embodiment laminate may be to use steel skin sheets coated with a Zn—Fe alloy layer on both surfaces (as explained before with regards to the first embodiment) to form a laminate with a viscoelastic core material sandwiched there between. Next, the entire laminate may be electro-galvanized to provide a substantially pure zinc layer on the exterior surfaces.

In a third embodiment, a steel laminate is formed having steel skin sheets with different coatings on the interior and exterior surfaces. The laminate has a galvanized zinc coating applied to the exterior surface and a Zn—Fe alloy coating applied to the interior surface. The laminate is also made using a viscoelastic core that contains conductive particles. The resulting laminate is shown in FIG. 4 looking at an edge portion (at location 2) of panel 10 of FIG. 1.

In this embodiment, the panel 10 steel laminate comprises a first steel skin sheet 400, and a second steel skin sheet 402 (each about 0.5 mm thick) that sandwich a viscoelastic polymer core layer 404 that is generally co-extensive with facing surfaces of steel skin sheets 400, 402 and about 0.04 mm thick. Again, it is seen that each steel skin sheet 400, 402 has a surface facing polymer core layer (termed an inner surface) and a surface opposite the core layer (termed an outer surface). And again polymer core 404 comprises about one to about two percent by volume dispersed conductive particles 406 to provide suitable electrical conductivity through the usually non-conductive core material and between the inner surfaces of the sheets.

In this embodiment, only the inner surfaces of both steel skin sheets 400, 402 are coated with a layer 408 of zinc-iron alloy that may be about 0.004 to about 0.012 millimeters in thickness. In another embodiment, the layer 408 may be about 0.002 mm to about 0.020 mm thick. In this example, the zinc-iron alloy comprises about 10 weight percent iron and 90 weight percent zinc. In other embodiments, the zinc-iron alloy may comprise about 9 to about 12 weight percent iron. In another embodiment, the zinc-iron alloy may comprise from about 5 weight percent up to about 30 weight percent iron. Thus, the third embodiment laminate 10 comprises only two zinc-iron alloy layers 408 on the inner faces of sheets 400, 402 and in contact with polymer core layer 404 and conductive particles 406. The outside faces of steel skin sheets 400, 402 are coated with relatively thick substantially pure zinc layers 410 about 0.006 to about 0.012 millimeters (about six to twelve micrometers) in thickness. Thus, zinc galvanized layers 410 on the outside steel sheet faces of the panel laminate 10 are exposed to the panel environment.

In this third embodiment, the substantially pure zinc exterior layer would provide the painting performance of galvanized steel sheet as well as good lubricity and resistance to surface cracking to enhance formability. The Zn—Fe alloy layer on the interior surfaces provides improved corrosion protection compared to a similar coating weight of substantially pure zinc. Finally, elimination of substantially pure zinc at the interior surface should benefit both resistance spot and drawn arc stud welding by reducing zinc vaporization.

One method of producing this third embodiment of steel laminate would be to electrocoat a single side of the skin sheet material with a Zn—Fe alloy. These skin sheets would then be laminated together with the bare steel surfaces exposed. Next, a substantially pure zinc layer would be applied to the exterior surfaces of the laminate by electro-galvanizing.

And in a fourth embodiment of the invention, a zinc-iron alloy corrosion resistant coating, e.g., about four micrometers to about twelve micrometers thick, is applied to each of the intended inner steel sheet surfaces and to the intended outer sheet surfaces of the steel laminate. In another embodiment, the zinc-iron alloy coating may be about 2 micrometers to about 20 micrometers thick. No substantially pure zinc coating is used in this embodiment. As in each of the above examples, the zinc-iron alloy may comprise, by weight, about five to thirty percent iron, and the balance substantially all zinc. In another embodiment, the zinc-iron alloy may comprise about 10 weight percent iron. In another embodiment, the zinc-iron alloy may comprise about 9 to about 12 weight percent iron.

A steel laminate in accordance with this fourth embodiment would have a cross-section like the laminate of FIG. 2 without the substantially pure zinc layers 210 or like the laminate of FIG. 3 without the substantially pure zinc layers 310. A steel laminate with two inner and two outer layers of zinc-iron alloy would, for example, provide good corrosion resistance in applications where forming operations, joining operations, painting operations and the like are not encumbered by the iron content of any of the four zinc-iron alloy layers.

The invention has been illustrated by some specific embodiments but the scope of the invention is not limited to these examples.

1. A steel laminate article comprising:
first and second steel sheets facing and sandwiching a generally co-extensive core layer of viscoelastic polymer composition, the steel sheets having inner faces adjacent the core layer and opposing outer faces;
the inner face of one or both of the steel sheets being coated with a zinc-iron alloy containing, by weight, about five to thirty percent iron, the coated inner face being bonded to the polymer composition core layer; and
the outer face of at least one of the steel sheets being coated with at least one of the zinc-iron alloy or substantially pure zinc.

2. A steel laminate article as recited in claim 1 in which one or both of the outer faces of the steel sheet are coated with substantially pure zinc.

3. A steel laminate article as recited in claim 1 in which the first and second steel sheets each have a thickness in the range of about one-half millimeter to about two millimeters, and in which the core layer has a thickness of about twenty micrometers to about fifty micrometers.

4. A steel laminate article as recited in claim 1 in which the zinc-iron alloy coating contains, by weight, about nine to about twelve percent iron.

5. A steel laminate article as recited in claim 1 in which the thickness of the zinc-iron alloy coating is in the range of about two to about twenty micrometers.

6. A steel laminate article as recited in claim 4 in which the thickness of the zinc-iron alloy coating is in the range of about two to about twenty micrometers.

7. A steel laminate article as recited in claim 1 in which both inner and outer surfaces of both steel sheets are coated with the zinc-iron alloy.

8. A steel laminate article as recited in claim 7 in which the zinc-iron alloy coatings on the outer surfaces of the laminate are coated with substantially pure zinc.

9. A steel laminate article as recited in claim 7 in which each zinc-iron alloy coating is coated with substantially pure zinc.

10. A steel laminate article as recited in claim 1 in which the inner surfaces of both steel sheets are coated with the zinc-iron alloy.

11. A steel laminate article as recited in claim 1 in which the inner surfaces of both steel sheets are coated with a zinc-iron alloy and the outer surfaces of both steel sheets are coated with substantially pure zinc.

12. A steel laminate as recited in claim 11 in which the thickness of the substantially pure zinc coating is in the range of about six to about twelve micrometers.

13. A steel laminate as recited in claim 1 in which the thickness of the substantially pure zinc coating is about one micrometer.

14. A steel laminate as recited in claim 1 in which the thickness of the zinc-iron alloy coating is in the range of about four to about twelve micrometers.

15. A steel laminate article for inclusion in an automotive vehicle structure comprising:
first and second steel sheets facing and sandwiching a generally co-extensive core layer of viscoelastic polymer composition, the steel sheets having inner faces adjacent the core layer and opposing outer faces, each steel sheet having a thickness in the range of about 0.4 mm to about 0.7 mm and the core having a thickness of about 0.020 mm to about 0.050 mm;
the inner faces of the steel sheets being coated with at least one layer of a first zinc-based alloy, consisting essentially of zinc and iron, and comprising about five to about thirty weight percent iron, the zinc-based alloy being composed for integrity of the sheet/viscoelastic layer interface following electrical resistance welding processes and to minimize long term corrosion at the sheet/viscoelastic layer interface; and
the outer face of the steel sheets being coated with at least one layer of substantially pure zinc or a second zinc-based alloy, consisting essentially of zinc and iron, and composed to provide compatibility with a high-voltage cathodic electrodeposition system while providing corrosion protection in the coated condition.

16. A steel laminate article as recited in claim 15 in which the inner faces of both sheets are first coated with the first zinc-based alloy which is in turn coated with substantially pure zinc.

17. A steel laminate article as recited in claim 15 in which the outer faces of both sheets are coated with substantially pure zinc.

18. A steel article as recited in claim 15 in which the outer faces of both sheets are coated with the second zinc-based alloy.

19. A steel article as recited in claim 18 in which the outer faces of both sheets are first coated with the second zinc-based alloy which is in turn coated with substantially pure zinc.
